(19) United States
(12) Patent Application Publication
(10) Pub. No.: US 2026/0344705 A1
(43) Pub. Date: Nov. 5, 2026

(54) PET FOOD PRODUCT

(71) Applicant: Unicharm Corporation, Ehime (JP)

(72) Inventors: Tomomi Oki, Itami-shi (JP); Arata Ishikawa, Itami-shi (JP); Waka Sawada, Itami-shi (JP); Kazunori Inoue, Itami-shi (JP); Yuma Ikezaki, Itami-shi (JP)

(73) Assignee: Unicharm Corporation, Ehime (JP)

(21) Appl. No.: 19/487,902

(22) PCT Filed: Nov. 1, 2023
(86) PCT No.: PCT/JP2023/039419

§ 371 Date: Nov. 25, 2025

(30) Foreign Application Priority Data
Jun. 26, 2023 (JP) 2023-103976

(51) Int. Cl. A23K 40/10; A23K 50/42; G01N 3/08

(52) U.S. Cl. CPC A23K 40/10; A23K 50/42; G01N 3/08

(57) ABSTRACT

A pet food product including at least 10 or more grains of pet food grains having the same composition and the same form, in which in a case where a breaking force upon compression of 10 grains of the pet food grains at a constant compression speed under the following test conditions is measured, the pet food product has 50% or more of pet food grains having, in addition to a maximum peak of a breaking strength, a plurality of peaks that are equal to or more than half the height of the maximum peak.

### TECHNICAL FIELD

The present invention relates to a pet food product.

Priority is claimed on Japanese Patent Application No. 2023-103976, filed on Jun. 26, 2023, the content of which is incorporated herein by reference.

### BACKGROUND ART

Pet food can be categorized into a staple food and an in-between meal snack in a case where the feeding purposes are categorized with opportunity. The pet food as the staple food is called a “complete nutritional food” and is formulated to enable essential nutrients to be taken as consumed along with water.

On the other hand, the “in-between meal snack” is pet food that is intended to be given in a limited amount, for example, pet training and exercise, or as a reward.

As classification according to the purposes, the pet food can be categorized into a “complete nutritional food,” an “in-between meal snack,” a “therapy diet,” and a “food for other purposes” that does not fall under any of those.

In addition, the pet food is largely classified into a dry food having a moisture content of approximately 10%, a soft food having a moisture content of approximately 15% to 35%, and a wet food having a moisture content of approximately 80% according to a classification based on the moisture content. In recent years, there has been increasing demand for the dry-type pet food among those due to ease of handling, good storage properties, and the like.

In recent years, pet food having a small outer diameter and a small thickness has become mainstream, in particular, in pet food for dogs and cats from the viewpoint of improving palatability.

It was considered that the pet food having a small outer diameter and a small thickness is highly palatable since it is easy to eat. However, in a case where the outer diameter and the thickness of the pet food are small, pets may swallow the pet food without chewing, which can lead to health concerns such as overeating and choking.

As a method for preventing pets from eating fast, a pet food bowl having a lid, which is designed to prevent the pets from eating fast and from obesity, is disclosed in Patent Document 1.

### CITATION LIST

### Patent Document

Patent Document 1: Japanese Unexamined Patent Application, First Publication No. 2020-130158

### SUMMARY OF INVENTION

### Technical Problem

Although there is a pet food bowl for preventing pets from eating too fast, such as the pet food bowl disclosed in Patent Document 1, pet food that can prevent pets from eating too fast has not been developed.

The present invention has been made in view of the circumstances, and an object of the present invention is to provide a pet food product that can induce pets to chew and eat the pet food, and can prevent the pets from eating fast.

### Solution to Problem

In order to solve the problems, the present inventors have conducted intensive studies.

As a result, they have found that pets can be induced to chew and eat pet food by controlling the breaking strength of the pet food. More specifically, the present invention employs the following aspects.

The present invention has the following aspects.

[1] A pet food product including:
at least 10 or more grains of pet food grains having the same composition and the same form,
in which in a case where a breaking force upon compression of 10 grains of the pet food grains at a constant compression speed under the following test conditions is measured, the pet food product has 50% or more of pet food grains having, in addition to a maximum peak of a breaking strength, a plurality of peaks that are equal to or more than half a height of the maximum peak.

### <Test Conditions>

Compression tester (texture analyzer, model number: EZ-SX, manufactured by Shimadzu Corporation)
Plunger: Canine-like plunger having a diameter of 10 mm
Platform: Flat plate (inner diameter of 26.5 mm×depth of 4 mm)
Compression speed: 60 mm/min
Lowest point of plunger: 4.0 mm (compression distance)
Measurement temperature: 25 °C
Break detection start point: 0.035% (0.14 N)
Test force: Full scale 500 N
Sensitivity of peak: 0.5% (2.5 N)

[2] The pet food product according to [1],
in which in the pet food grains, an arithmetic mean surface roughness Sa1 of first surfaces obtained by projecting the pet food grains in a first direction is less than 14 μm, and
an arithmetic mean surface roughness Sa2 of surfaces obtained by projecting the pet food grains in a direction other than the first direction is 14 μm or more.

[3] The pet food product according to [1] or [2],
in which in a case where hardnesses of 10 grains of the pet food grains are measured, the average of the hardnesses is 30 N or less.

[4] The pet food product according to [2],
in which the height of the pet food grain in a case where a surface obtained by projecting the pet food grain in a second direction orthogonal to the first direction is defined as a bottom surface is larger than the length of the pet food grain in the first direction.

[5] The pet food product according to [4],
in which in a case where the heights of 10 grains of the pet food grains are measured, the average of the heights is 10 mm or more.

[6] A pet food product including:
at least 10 or more grains of pet food grains having the same configuration and the same form,
in which in a case where a breaking force upon compression of 10 grains of the pet food grains at a constant compression speed under the following test conditions is measured, the pet food product has 70% or more of pet food grains having a total weight of fragments remaining in a 7 mm×7 mm mesh, which is 90% or more of the weight before the measurement.

### <Test Conditions>

Compression tester (texture analyzer, model number: EZ-SX, manufactured by Shimadzu Corporation)
Plunger: Canine-like plunger having a diameter of 10 mm
Platform: Flat plate (inner diameter of 26.5 mm×depth of 4 mm)
Compression speed: 60 mm/min
Lowest point of plunger: 4.0 mm (compression distance)
Measurement temperature: 25 °C
Break detection start point: 0.035% (0.14 N)
Test force: Full scale 500 N
Sensitivity of peak: 0.5% (2.5 N)

### Advantageous Effects of Invention

According to the present invention, it is possible to provide a pet food product that can induce pets to chew and eat the pet food product, and can prevent fast eating.

### BRIEF DESCRIPTION OF DRAWINGS

FIG. 1 A schematic view showing a plunger used in a case of measuring a breaking force.

FIG. 2 A schematic view showing a pet food grain in a pet food product according to a first aspect of the present invention.

FIG. 3 A schematic view showing a surface obtained by projecting pet food grains in the pet food product according to the first aspect of the present invention from each side.

FIG. 4 A graph showing the measurement results of the breaking strength of pet food grains in pet food products of Examples.

FIG. 5 A graph showing the measurement results of the breaking strength of pet food grains in pet food products of Comparative Examples.

### DESCRIPTION OF EMBODIMENTS

In the present specification, the term “pet” refers to an animal raised by a person. In a narrower sense, pets are animals that are kept and cherished by their owners. In addition, the term “pet food” refers to feed for pets. The pet food according to the present invention can be sold as “feed for animals” or “animal feed”.

In the present specification, the term “palatability” is an index indicating whether or not a pet favors to eat, and is affected by the texture, the taste, the odor, and the like.

In the present specification, the value of a moisture content is a value obtained by a normal-pressure heating and drying method.

In the normal-pressure heating and drying method, an object to be measured is crushed with a crusher to pass through a 1 mm sieve, the crushed object is used as an analysis sample, 2 to 5 g of the analysis sample is accurately weighed and placed in an aluminum-made weighing dish, the analysis sample is dried at 135 °C for 2 hours, the analysis sample is allowed to cool in a desiccator, the weight of the analysis sample is accurately weighed, and the moisture content is obtained from the weight difference of the analysis sample before and after drying.

More specifically, the object to be measured is crushed with a crusher and passed through a 1 mm sieve, and the crushed object is used as an analysis sample. A mass (W1 grams) of an aluminum weighing can is measured in advance as a constant amount value. An analysis sample is put in the aluminum weighing can to weigh a mass (W2 grams). Next, the analysis sample is dried at 135 °C for 2 hours using a forced circulation type hot air dryer. The analysis sample is allowed to cool in a dry atmosphere (in a silica gel desiccator), and then a mass (W3 grams) is weighed. The moisture content of the analysis sample is determined from each of the obtained masses using the following expression.

Moisture content of analysis sample (unit: % by mass)=(W2−W3)÷(W2−W1)×100. The moisture content is a value measured immediately after the final product is opened within 30 days from the manufacturing date, or a value measured under equivalent conditions.

In the present specification, the hardness of the pet food grain is a value obtained by the following method.

One pet food grain as a measurement target is placed on a flat plate (inner diameter of 26.5 mm×depth of 4 mm), and the stress is measured while pressing a plunger vertically from directly above a center part of the pet food grain at a constant speed. A peak value (maximum value) of the stress is read as the value of the breaking stress. The unit of the numerical value of the breaking hardness can be converted into Newton (N) by multiplying the numerical value of the breaking stress (unit: kgw) to be measured by a compression tester by 9.8.

### <Test Conditions>

Compression tester (texture analyzer, model number: EZ-SX, manufactured by Shimadzu Corporation)
Plunger: Canine-like plunger having a diameter of 10 mm
Platform: Flat plate (inner diameter of 26.5 mm×depth of 4 mm)
Compression speed: 60 mm/min
Lowest point of plunger: 4.0 mm (compression distance)
Measurement temperature: 25 °C
Break detection start point: 0.035% (0.14 N)
Test force: Full scale 500 N
Sensitivity of peak: 0.5% (2.5 N)

In the present specification, the arithmetic mean surface roughness Sa is calculated for the surface of the pet food grains by performing surface observation of the pet food grains (magnification: 40 times, observation visual field area: 19 to 20 mm²) using a non-contact three-dimensional shape measuring device VR-3200 (manufactured by Keyence Corporation, using an L filter with nesting index of 0.25 mm).

### (Pet Food Product of First Embodiment)

The pet food product according to the present embodiment has at least 10 or more grains of pet food grains having the same composition and the same form.

It is preferable that the pet food product according to the present embodiment is a complete nutritional food.

The term “complete nutritional food” is a product that is intended to be fed to dogs or cats as a main daily meal among pet foods, and is a nutritionally balanced product that can maintain health at a designated growth stage with only the pet food and water. As a standard for the complete nutritional food, for example, a standard determined by the Association of American Feed Control Officials (AAFCO) may be used.

Furthermore, in the present specification, “complete nutritional food” may be food that satisfies a standard of any stage of “puppy/kitten stage/growth stage or growth”, “adult dog stage and adult cat stage/maintenance stage or maintenance”, or “pregnancy stage/lactation stage”, regardless of the growth stage, or may be food that satisfies all three stages, which is referred to as “all growth stages” or “for all stages”.

Each parameter (the breaking strength, the thickness, the minor axis, the hardness, and the like) of the pet food according to the present embodiment means the average value of values of 10 grains of a plurality of pet food grains having the same composition and form and manufactured under the same conditions, not a value of one grain of the pet food grains.

For example, each parameter means the average value of the values of 10 grains of the pet food grains randomly taken out from a plurality of pet food grains included in a packaged dry-type pet food product.

Therefore, in a case where the average value satisfies each parameter, the product is the pet food product according to the present embodiment.

In a case where a breaking force upon compression of 10 grains of the pet food grains at a constant compression speed under the following test conditions is measured, the pet food product according to the present embodiment has 50% or more of pet food grains having, in addition to a maximum peak of a breaking strength, a plurality of peaks that are equal to or more than half the height of the maximum peak. The parameter can be controlled by appropriately adjusting the expansion time in a case of manufacturing the pet food, the shape of the pet food, and the like.

### <Test Conditions>

Compression tester (texture analyzer, model number: EZ-SX, manufactured by Shimadzu Corporation)
Plunger: Canine-like plunger having a diameter of 10 mm
Platform: Flat plate (inner diameter of 26.5 mm×depth of 4 mm)
Compression speed: 60 mm/min
Lowest point of plunger: 4.0 mm (compression distance)
Measurement temperature: 25 °C
Break detection start point: 0.035% (0.14 N)
Test force: Full scale 500 N
Sensitivity of peak: 0.5% (2.5 N)

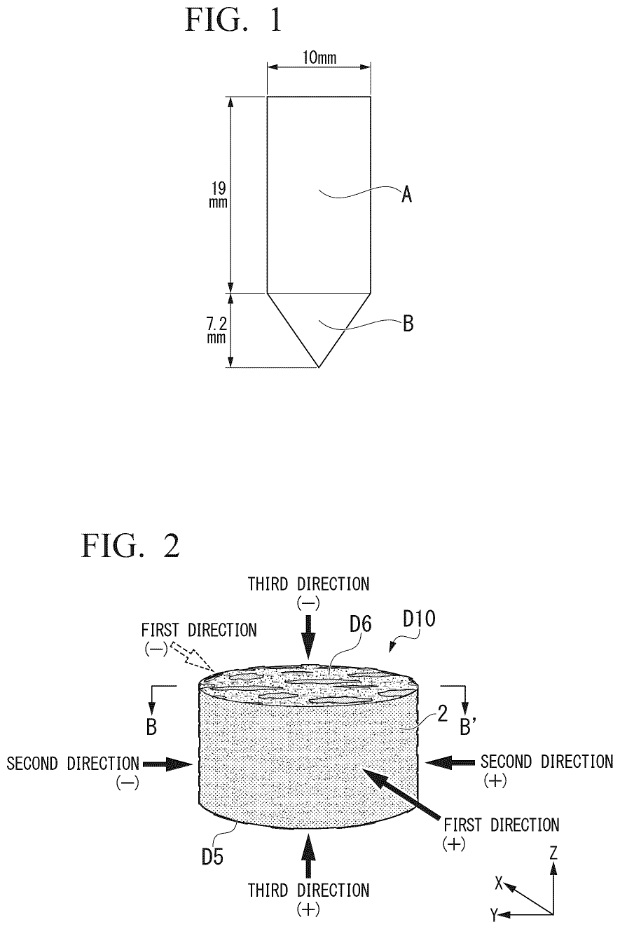

More specifically, the canine-like plunger having a diameter of 10 mm has a cylindrical connecting part A having a diameter of 10 mm and a height of 19 mm, and a conical pressing part B having a height of 7.2 mm, as shown in FIG. 1.

In a case where a breaking force upon compression of 10 grains of the pet food grains at a constant compression speed under the test conditions is measured, the pet food grains in the pet food product according to the present embodiment have 50% or more, preferably 60% or more, more preferably 70% or more, and still more preferably 80% or more of pet food grains having, in addition to a maximum peak of a breaking strength, a plurality of peaks that are equal to or more than half the height of the maximum peak.

By configuring the pet food grains in the pet food product according to the present embodiment to have 50% or more of pet food grains having, in addition to a maximum peak of a breaking strength, a plurality of peaks that are equal to or more than half the height of the maximum peak, a chewing force is continuously required until the pet food grains are completely crushed, and pets can be induced to chew the pet food grains multiple times, making it possible to prevent the pets from eating too fast.

In a case where a breaking force upon compression of 10 grains of the pet food grains at a constant compression speed under the test conditions is measured, the pet food grains in the pet food product according to the present embodiment preferably have 70% or more, more preferably has 80% or more, and still more preferably has 90% or more of pet food grains having a total weight of fragments remaining in a 7 mm×7 mm mesh, which is 90% or more of the weight before the measurement.

With regard to the pet food grains in the pet food product according to the present embodiment, by configuring the pet food grains in the pet food product to have 70% or more of pet food grains having a total weight of fragments remaining in a 7 mm×7 mm mesh, which is 90% or more of the weight before the measurement in a case where the breaking force measurement is performed, a large lump of grains is likely to remain even after pets chew the pet food once. Thus, the pets can be induced to chew the pet food multiple times, and can thus be prevented from eating fast.

It is preferable that in the pet food grains in the pet food product according to the present embodiment, an arithmetic mean surface roughness Sa1 of a first surface obtained by projecting the pet food grain in a first direction is less than 14 μm, and an arithmetic mean surface roughness Sa2 of a surface obtained by projecting the pet food grain in a direction other than the first direction is 14 μm or more. That is, it is preferable that the pet food grains in the pet food product according to the present embodiment have surfaces with different surface roughnesses.

By configuring the pet food grains to have the surfaces with different surface roughnesses, pets can enjoy a plurality of textures. Therefore, the palatability is further improved.

In addition, it is preferable that in the pet food grain in the pet food product according to the present embodiment, the height of the pet food grain in a case where the surface obtained by projecting the pet food grain in a second direction orthogonal to the first direction is defined as a bottom surface is larger than the length of the pet food grain in the first direction. That is, it is preferable that the pet food grain having a surface that is not rough is thicker.

With regard to the pet food grain in the pet food product according to the present embodiment, it is more preferable that the height of the pet food grain in a case where the surface obtained by projecting the pet food grain in a second direction orthogonal to the first direction is defined as a bottom surface is larger than the length of the pet food grain in the first direction. Therefore, pets can be induced to start chewing from a surface that is not rough, and the palatability is further improved.

The height (thickness) of the pet food grain in the pet food product according to the present embodiment is preferably 1.10 times, more preferably 1.13 times, and still more preferably 1.15 times the length (major axis) of the pet food grain in the first direction.

The arithmetic mean surface roughness Sa1 of the first surface of the pet food grains in the pet food product according to the present embodiment is preferably less than 14 μm, more preferably 13 μm or less, and still more preferably 12 μm or less.

The arithmetic mean surface roughness Sa2 of the surface obtained by projecting the pet food grain in a direction other than the first direction in the pet food grains in the pet food product according to the present embodiment is preferably 14 μm or more, more preferably 16 μm or more, and still more preferably 18 μm or more.

In a case where the hardnesses of the pet food grains in the pet food product according to the present embodiment are measured, the average of the hardnesses is preferably 30 N or less, more preferably 29 N or less, and still more preferably 28 N or less.

In a case where the hardness of the pet food grains is equal to or less than the preferred value, the pet food is easily chewed, and the palatability is further improved.

The height of the pet food grain in the pet food product according to the present embodiment is preferably 10 mm or more, more preferably 10.5 mm or more, and still more preferably 11 mm or more.

By configuring the height of the pet food grain in the pet food product according to the present embodiment to be 10 mm or more, pets can be induced to chew and eat the pet food grains, and can be further prevented from eating fast.

It is preferable that the pet food grains in the pet food product according to the present embodiment have 50% or more of the pet food grains having a height of 10 mm or more.

By configuring the pet food grains in the pet food product according to the present embodiment to have 50% or more of the pet food grains having a height of 10 mm or more, pets can be induced to chew and eat the pet food grains, and can be further prevented from eating fast.

The pet food grains in the pet food product according to the present embodiment preferably have 50% or more, more preferably have 60% or more, and still more preferably have 70% or more of the pet food grains having a height of 10 mm or more.

The major axis or diameter of the pet food grains in the pet food product according to the present embodiment is preferably 5 mm or more, more preferably 7 mm or more, and still more preferably 9 mm or more. In addition, the major axis or diameter of the pet food grains in the pet food product according to the present embodiment is preferably 13 mm or less, more preferably 12 mm or less, and still more preferably 11 mm or less.

For example, the major axis or diameter of the pet food grains in the pet food product according to the present embodiment is preferably 5 mm or more and 13 mm or less, more preferably 7 mm or more and 12 mm or less, and still more preferably 9 mm or more and 11 mm or less.

The minor axis of the pet food grains in the pet food product according to the present embodiment is preferably 4 mm or more, more preferably 6 mm or more, and still more preferably 8 mm or more.

In addition, the minor axis of the pet food grains in the pet food product according to the present embodiment is preferably 11 mm or less, more preferably 10 mm or less, and still more preferably 9 mm or less.

For example, the minor axis of the pet food grains in the pet food product according to the present embodiment is preferably 4 mm or more and 11 mm or less, more preferably 6 mm or more and 10 mm or less, and still more preferably 8 mm or more and 9 mm or less.

The shape of the pet food grains in the pet food product according to the present embodiment is not particularly limited as long as it is a shape suitable for pets to eat.

For example, any shape such as spherical, ellipsoidal (go-stone-like), pellet-like, cylindrical, polygonal columnar, hexahedral (plate-like), clover-like, heart-like, star-like, and cross-like shapes can be applied. Among these, from the viewpoint of making it easy to obtain the effect of the present invention, the cylindrical shape is preferable.

### <<Raw Material>>

As a raw material of the pet food product according to the present embodiment, known powder raw materials and liquid raw materials in the manufacture of pet food can be used.

Specific examples of the powder raw material include cereals (corn, wheat, wheat flour, wheat bran, rice, bread crumbs, barley, oats, rye, and the like), tubers (sweet potato, potato, and the like), beans (whole soybeans and the like), starches (wheat starch, corn starch, rice starch, potato starch, tapioca starch, sweet potato starch, sago starch, processed starch, and the like), vegetable proteins (corn gluten meal, wheat protein, bean protein, rice protein, tuber protein, and the like), meat (livestock meat and game meat such as beef, pork, sheep, deer, and rabbit; poultry meat such as chicken, turkey, quail, and fowl; and meals (chicken meal, pork meal, beef meal, and mixed meal thereof)), fish and shellfish (fish such as tuna, bonito, and horse mackerel; crustaceans such as shrimp and crab; mollusks such as octopus and squid; shellfish such as scallops and turban shells; fish extracts; dried bonito, and meals (fish meal)), vegetables, seeds, mushrooms, eggs, sugars, milks, and additives (vitamins, minerals, amino acids, flavoring ingredients, powdery palatability improvers, fibers, colorants, phosphates, pH adjusters, seasonings, antioxidants, trehalose, and the like).

The meal denotes powder obtained by compressing and finely crushing meat or fish and shellfish. More specific examples of the powdery palatability improver include an animal raw material extract, a plant raw material extract, a yeast extract, and a dried product of a yeast.

Specific examples of the liquid raw material (including semi-solid raw material) include water, oils and fats (animal oils and fats such as chicken oil, lard, tallow, dairy fat, and fish oil; and vegetable oils and fats such as olive oil, cacao oil, palm oil, palm kernel oil, coconut oil, coconut butter, and camellia oil), liquid palatability improvers, liquid sugar, moisturizing agents, preservatives, emulsifiers, fragrances, and colorants.

Formulation Examples of the (dry-type) pet food product according to the present embodiment are shown below.

40% to 70% of cereals, 5% to 30% of meat, 1% to 15% of fish and shellfish, 1% to 15% of beans, 1% to 10% of fibers, 1% to 5% of vitamins, minerals, and amino acids, and 1% to 10% of animal oil and fat (a total thereof is 100%).

### (Pet Food Product of Second Embodiment)

The pet food product according to the present embodiment has at least 10 or more grains of pet food grains having the same composition and the same form.

In a case where a breaking force upon compression of 10 grains of the pet food grains at a constant compression speed under the following test conditions is measured, the pet food product according to the present embodiment has 70% or more of pet food grains having a total weight of fragments remaining in a 7 mm×7 mm mesh, which is 90% or more of the weight before the measurement.

### <Test Conditions>

Compression tester (texture analyzer, model number: EZ-SX, manufactured by Shimadzu Corporation)
Plunger: Canine-like plunger having a diameter of 10 mm
Platform: Flat plate (inner diameter of 26.5 mm×depth of 4 mm)
Compression speed: 60 mm/min
Lowest point of plunger: 4.0 mm (compression distance)
Measurement temperature: 25 °C
Break detection start point: 0.035% (0.14 N)
Test force: Full scale 500 N
Sensitivity of peak: 0.5% (2.5 N)

In the pet food product according to the present embodiment, in a case where a breaking force upon compression of 10 grains of the pet food grains at a constant compression speed under the test conditions is measured, the pet food grains in the pet food product has 70% or more, preferably 80% or more, and more preferably 90% or more of pet food grains having a total weight of fragments remaining in a 7 mm×7 mm mesh, which is 90% or more of the weight before the measurement. With regard to the pet food grains in the pet food product according to the present embodiment, by configuring the pet food grains in the pet food product to have 70% or more of pet food grains having a total weight of fragments remaining in a 7 mm×7 mm mesh, which is 90% or more of the weight before the measurement in a case where the breaking force measurement is performed, a large lump of grains is likely to remain even after pets chew the pet food once. Thus, the pets can be induced to chew the pet food multiple times, and can thus be prevented from eating fast.

In a case where a breaking force upon compression of 10 grains of the pet food grains at a constant compression speed under the test conditions is measured, the pet food grains in the pet food product according to the present embodiment preferably has 50% or more, more preferably have 60% or more, still more preferably has 70% or more, and particularly preferably has 80% or more of pet food grains having, in addition to a maximum peak of a breaking strength, a plurality of peaks that are equal to or more than half the height of the maximum peak.

By configuring the pet food grains in the pet food product according to the present embodiment to have 50% or more of pet food grains having, in addition to a maximum peak of a breaking strength, a plurality of peaks that are equal to or more than half the height of the maximum peak, a chewing force is continuously required until the pet food grains are completely crushed, and pets can be induced to chew the pet food grains multiple times, making it possible to prevent the pets from eating too fast.

A preferred aspect of the pet food grains in the pet food product according to the present embodiment is the same as that of the above-described pet food product of the first embodiment.

### (Pet Food Grains in Pet Food Product According to First Aspect)

Hereinafter, as a specific aspect of the pet food product according to the present embodiment, the pet food grains in the pet food product according to the first aspect will be described in detail with reference to the drawings.

In the following description, an orthogonal coordinate system with X, Y, and Z will be used as necessary. In this case, the Z direction represents the height direction (gravitational direction). Two directions orthogonal to the Z direction are the X direction and the Y direction. In the figure, the arrow side is defined as a plus (+) side, and the side opposite to the arrow is referred to as a minus (−) side. For example, the +Z side corresponds to an upper side in the height direction, and the −Z side corresponds to a lower side in the height direction.

In a pet food grain D10 shown in FIG. 2, the surface obtained by projecting the pet food grain D10 toward the +X side in the first direction is defined as a first surface D1. In addition, the surface obtained by projecting the pet food grain D10 toward the −X side in the first direction is defined as a fourth surface D4.

In the pet food grain D10, the surface obtained by projecting the pet food grain D10 toward the +Z side in the second direction orthogonal to the first direction is defined as a fifth surface D5. In addition, the surface obtained by projecting the pet food grain D10 toward the B side, −Z side, in the second direction orthogonal to the first direction is defined as a sixth surface D6.

In the pet food grain D10, the surface obtained by projecting the pet food grain D10 toward the +Y side in the third direction orthogonal to the first direction is defined as a second surface D2. In addition, the surface obtained by projecting the pet food grain D10 toward the −Y side in the second direction orthogonal to the first direction is defined as a third surface D3.

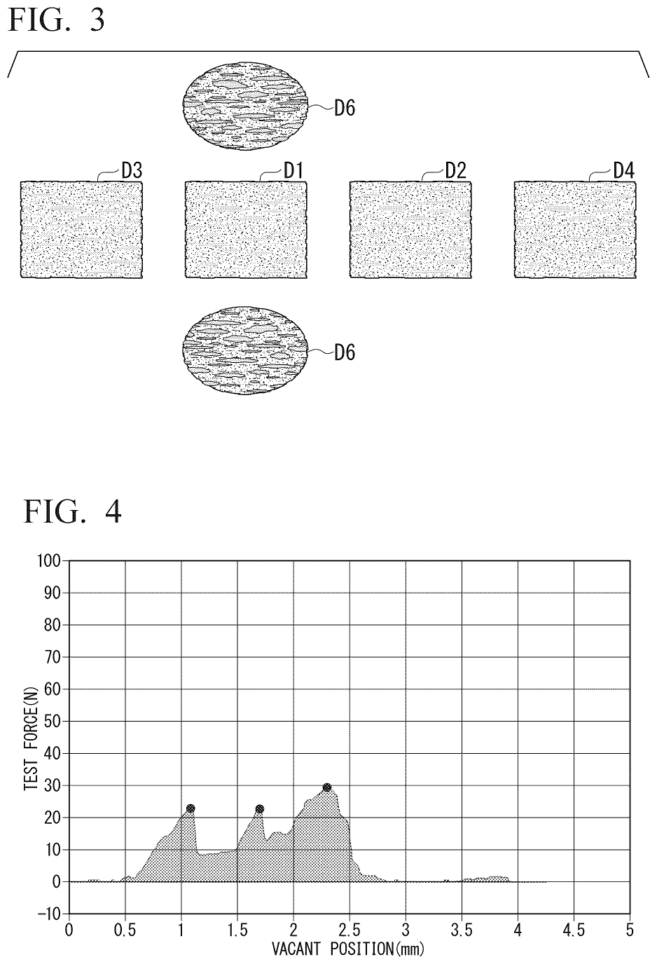

FIG. 3 is a view showing surfaces obtained by projecting the pet food grain D10 in each direction, that is, the first surface D1 to the sixth surface D6.

In the pet food grain D10, the first surface D1 to the fourth surface D4 are surfaces having an arithmetic mean surface roughness Sa1 of less than 14 μm, and the fifth surface D5 and the sixth surface D6 are surfaces having an arithmetic mean surface roughness Sa2 of 14 μm or more.

The preferred parameters and the raw materials of the pet food grain D10 are each as described above.

### EXAMPLES

Hereinafter, the present invention will be further described in detail with reference to Examples, but is not limited to Examples.

### (Manufacture of Complete Nutritional Pet Food)

### Example 1

Raw materials of pet food grains in a pet food product of Example 1 were mixed following the formulation shown in Table 1. The obtained raw material mixture was put into an extruder and subjected to a heat treatment under kneading so that starch components were pregelatinized, and the mixture was extruded and granulated into a grain shape at an outlet of the extruder, expanded for 0.04 seconds, and then cut to obtain grains (expansion time: 0.04 seconds). The obtained grains were subjected to a drying treatment using a dryer to manufacture the pet food product of Example 1, which had at least 10 or more grains of pet food grains having the same composition and the same form.

Furthermore, the form of the pet food grain in the pet food product of Example 1 is the same as that of the pet food grain D10 shown in FIG. 3.

The major axis, the minor axis, and the thickness of each of 10 randomly selected pet food grains in the pet food product of Example 1 were measured with a caliper, and average values thereof were determined. The results were 9.5 mm in major axis, 8.5 mm in minor axis, and 11 mm in thickness.

In addition, the average value of the bulk specific gravities was determined through measurement by freely dropping 10 randomly selected pet food grains in the pet food product of Example 1 from a height of 20 cm into a 1 L cup having a diameter of 11 cm, and using the weight of the grains that filled the cup to the brim. As a result, the average of the bulk specific gravities of the pet food grains was 285.5 (g/L).

In addition, with regard to the arithmetic mean surface roughness of the 10 randomly selected pet food grains in the pet food product of Example 1, surface observation of the pet food grains (magnification: 40×, observation visual field area: 19 to 20 mm²) was carried out using a non-contact three-dimensional shape measuring device VR-3200 (manufactured by Keyence Corporation, using an L filter with a nesting index of 0.25 mm), and the average value of the arithmetic mean roughness Sa for the surfaces of the pet food grains was determined. As a result, the arithmetic mean surface roughness Sa1 of the first surface D1 to the fourth surface D4 of the pet food grains was 13.1 μm. In addition, the average of the arithmetic mean surface roughness of the fifth surface D5 and the sixth surface D6 was 19.6 μm.

### Comparative Example 1

Raw materials of pet food grains in a pet food product of Comparative Example 1 were mixed following the formulation shown in Table 1 (the same formulation as in Example 1). The obtained raw material mixture was put into an extruder and subjected to a heat treatment while being kneaded so that starch components were pregelatinized, and the mixture was cut simultaneously with extrusion and granulation of the mixture in a grain shape at an outlet of the extruder to obtain grains (expansion time: 0 seconds). The obtained grains were subjected to a drying treatment using a dryer to manufacture the pet food product of Comparative Example 1, which had at least 10 or more grains of pet food grains having the same composition and the same form.

The major axis, the minor axis, and the thickness of each of 10 randomly selected pet food grains in the pet food product of Comparative Example 1 were measured with a caliper, and average values thereof were determined. The results were 9.0 mm in major axis, 9.0 mm in minor axis, and 5 mm in thickness.

In addition, the average value of the bulk specific gravities was determined through measurement by freely dropping 10 randomly selected pet food grains in the pet food product of Comparative Example 1 from a height of 20 cm into a 1 L cup having a diameter of 11 cm, and using the weight of the grains that filled the cup to the brim. As a result, the average of the bulk specific gravities of the pet food grains was 370.0 (g/L).

TABLE 1

| | Example 1 | Comparative Example 1 |
|---|---|---|
| Cereals | 64.5 | 64.5 |
| Meat | 10.5 | 10.5 |
| Fish and shellfish | 9.0 | 9.0 |
| Beans | 6.5 | 6.5 |
| Fats and oils | 6.0 | 6.0 |
| Fibers | 2.0 | 2.0 |
| Vitamins, minerals, and amino | 1.5 | 1.5 |
| acids | | |
| Total | 100 | 100 |

[Number of Peaks that are Equal to or More than Half Height of Maximum Peak]

With regard to the 10 randomly selected pet food grains in the pet food products of Example 1 and Comparative Example 1, a breaking force upon compression of the pet food grains at a constant compression speed under the following test conditions was measured, and the numbers of peaks that are equal to or more than half the height of a maximum peak of the breaking strength, in addition to the maximum peak, were each detected. Specifically, one pet food grain as a measurement target is placed on a flat plate (inner diameter of 26.5 mm×depth of 4 mm), and the measurement was performed while pressing a plunger vertically from directly above a center part of the pet food grain at a constant speed. The results are shown in Tables 2 and 3.

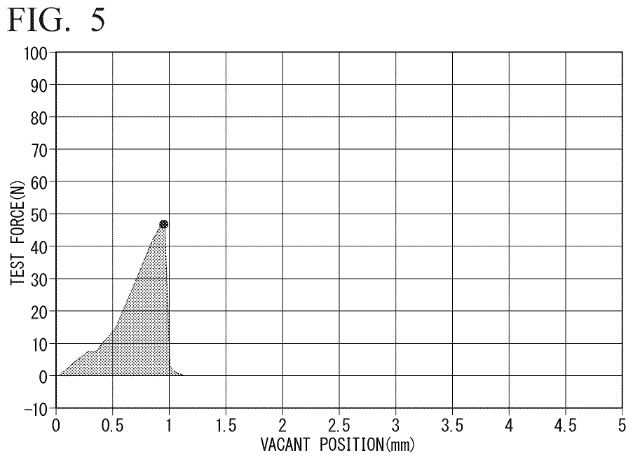

In addition, a graph of the measurement results of the food grains of Example 1 is shown in FIG. 4. In addition, a graph of measurement results of the food grains of Comparative Example 1 is shown in FIG. 5.

### <Test Conditions>

Compression tester (texture analyzer, model number: EZ-SX, manufactured by Shimadzu Corporation)
Plunger: Canine-like plunger having a diameter of 10 mm
Platform: Flat plate (inner diameter of 26.5 mm×depth of 4 mm)
Compression speed: 60 mm/min
Lowest point of plunger: 4.0 mm (compression distance)
Measurement temperature: 25 °C
Break detection start point: 0.035% (0.14 N)
Test force: Full scale 500 N
Sensitivity of peak: 0.5% (2.5 N)

### [Hardness]

A maximum peak of the breaking strength of each of 10 randomly selected pet food grains in the pet food products of Example 1 and Comparative Example 1 was measured by the same method as in [Number of Peaks That Are equal to or more than half the height of Maximum Peak] above. The unit was converted into Newton (N) by multiplying the maximum peak value (unit: kgw) of the breaking strength by 9.8. The results are shown in Tables 2 and 3.

### [Stroke]

A distance (a distance until the plunger comes into contact with the pet food grain and the pet food grain is broken) required to reach the maximum peak of the breaking strength of each of 10 randomly selected pet food grains in the pet food products of Example 1 and Comparative Example 1 was measured by the same method as in [Number of Peaks That Are equal to or more than half the height of Maximum Peak] above. The results are shown in Tables 2 and 3.

### [Brittleness]

A difference (convex point-concave point) between the maximum peak of the breaking strength and the minimum value up to the adjacent peak was measured for each of 10 randomly selected pet food grains in the pet food products of Example 1 and Comparative Example 1 by the same method as in [Number of Peaks That Are equal to or more than half the height of Maximum Peak] above. The results are shown in Tables 2 and 3.

TABLE 2

| | Number of peaks | | | |
|---|---|---|---|---|
| | that are equal | | | |
| | to or more than | | | |
| | half height of | Hardness | Stroke | |
| Example 1 | maximum peak | (N) | (mm) | Brittleness |
| Food grains 1 | 2 | 25.928 | 1.310 | 3.831 |
| Food grains 2 | 3 | 31.678 | 1.550 | 9.838 |
| Food grains 3 | 0 | 27.934 | 1.329 | 14.127 |
| Food grains 4 | 2 | 25.934 | 2.330 | 5.464 |
| Food grains 5 | 2 | 29.622 | 2.299 | 14.200 |
| Food grains 6 | 3 | 20.293 | 2.400 | 2.720 |
| Food grains 7 | 1 | 25.759 | 1.030 | 4.021 |
| Food grains 8 | 4 | 27.738 | 2.210 | 11.833 |
| Food grains 9 | 4 | 30.580 | 2.181 | 6.710 |
| Food grains 10 | 2 | 33.370 | 2.260 | 4.612 |
| Average | 2.3 | 27.8836 | 1.889878 | 7.7356 |

TABLE 3

| | Number of peaks | | | |
|---|---|---|---|---|
| | that are equal | | | |
| | to or more than | | | |
| Comparative | half height of | Hardness | Stroke | |
| Example 1 | maximum peak | (N) | (mm) | Brittleness |
| Food grains 1 | 0 | 46.409 | 0.94963 | 45.728 |
| Food grains 2 | 2 | 39.140 | 1.44000 | 7.750 |
| Food grains 3 | 2 | 37.880 | 1.18100 | 7.524 |
| Food grains 4 | 0 | 48.087 | 1.31063 | 47.842 |
| Food grains 5 | 1 | 41.303 | 1.23063 | 4.470 |
| Food grains 6 | 0 | 51.116 | 1.40025 | 50.973 |
| Food grains 7 | 1 | 40.377 | 1.42950 | 40.059 |
| Food grains 8 | 1 | 51.882 | 1.21075 | 6.948 |
| Food grains 9 | 1 | 45.210 | 1.21063 | 8.321 |
| Food grains 10 | 2 | 48.501 | 1.32013 | 16.877 |
| Average | 1.0 | 44.9905 | 1.268315 | 23.6492 |

As shown in Tables 3 and 4, the pet food grains in the pet food product of Examples had, in addition to a maximum peak of a breaking strength, a plurality of peaks that are equal to or more than half the height of the maximum peak.

Therefore, it can be seen that a chewing force is continuously required until the pet food grains are completely crushed.

[Total Weight of Fragments of Pet Food Grains Remaining in 7 mm×7 mm Mesh]

In a case where the breaking force was measured by the same method as in [Number of Peaks That Are equal to or more than half the height of Maximum Peak] above, a total weight of the fragments remaining in a 7 mm×7 mm mesh, a weight of the pet food grains before measurement, and a proportion of the total weight of the fragments remaining in a 7 mm×7 mm mesh with respect to the weight of the pet food grains before measurement (total weight of fragments/weight of pet food grains before measurement) were calculated. The results are shown in Tables 4 and 5.

TABLE 4

| | | Weight of | Proportion of |
|---|---|---|---|
| Example 1 | Weight of grain | fragment | fragment |
| Food grains 1 | 0.29475 | 0.28763 | 97.6% |
| Food grains 2 | 0.26262 | 0.26062 | 99.2% |
| Food grains 3 | 0.41603 | 0.40787 | 98.0% |
| Food grains 4 | 0.33714 | 0.33015 | 97.9% |
| Food grains 5 | 0.39455 | 0.38993 | 98.8% |
| Food grains 6 | 0.37753 | 0.37127 | 98.3% |
| Food grains 7 | 0.30462 | 0.29445 | 96.7% |
| Food grains 8 | 0.34862 | 0.34501 | 99.0% |
| Food grains 9 | 0.36033 | 0.35619 | 98.9% |
| Food grains 10 | 0.31554 | 0.23905 | 75.8% |

TABLE 5

| | | Weight of | Proportion of |
|---|---|---|---|
| Comparative Example 1 | Weight of grain | fragment | fragment |
| Food grains 1 | 0.17162 | 0 | — |
| Food grains 2 | 0.16607 | 0 | — |
| Food grains 3 | 0.17889 | 0 | — |
| Food grains 4 | 0.18383 | 0.1381 | 75.1% |
| Food grains 5 | 0.18783 | 0 | — |
| Food grains 6 | 0.17858 | 0 | — |
| Food grains 7 | 0.16198 | 0 | — |
| Food grains 8 | 0.17385 | 0 | — |
| Food grains 9 | 0.15471 | 0.12579 | 99% |
| Food grains 10 | 0.16259 | 0 | — |

As shown in Tables 4 and 5, the pet food grains in the pet food products of Examples had a high proportion of the fragments remaining in a 7 mm×7 mm mesh after the measurement of the breaking force.

Therefore, it can be seen that large fragments are likely to remain in a case where a pet chews the pet food grains.

### [Evaluation of Fast Eating Prevention Effect]

The pet food product of Example 1 and the pet food product of Comparative Example 1 were given to a dog, and the time taken from the start of eating to the completion of eating was measured. In addition, the state of the dog eating the food was captured in a video, and the average value of the number of times of chewing one piece was measured. The results are shown in Table 6.

TABLE 6

| | | Time taken to | |
|---|---|---|---|
| | Total | consume one grain | Number of |
| | weight | (seconds) | chews |
| Example 1 | 25.5 | 1.2 | 3 |
| Comparative Example 1 | 25.5 | 0.53 | 0 |

As shown in Table 6, it was confirmed that the pet food products of Examples could increase the number of chewing times and slow down the meal eating pace, as compared to the pet food products of Comparative Examples.

Although preferred Examples of the present invention have been described above, the present invention is not limited to these Examples. Addition, omission, replacement, and other modifications can be made to the configuration without departing from the spirit of the present invention. Accordingly, the present invention is not limited by the description above but by the scope of the appended claims.

### REFERENCE SIGNS LIST

D10 Pet food grain

1. A pet food product comprising:
at least 10 or more grains of pet food grains having the same composition and the same form,
wherein in a case where a breaking force upon compression of 10 grains of the pet food grains at a constant compression speed under the following test conditions is measured, the pet food product has 50% or more of pet food grains having, in addition to a maximum peak of a breaking strength, a plurality of peaks that are equal to or more than half a height of the maximum peak,
<Test Conditions>
Compression tester (texture analyzer, model number: EZ-SX, manufactured by Shimadzu Corporation)
Plunger: Canine-like plunger having a diameter of 10 mm
Platform: Flat plate (inner diameter of 26.5 mm×depth of 4 mm)
Compression speed: 60 mm/min
Lowest point of plunger: 4.0 mm (compression distance)
Measurement temperature: 25 °C
Break detection start point: 0.035% (0.14 N)
Test force: Full scale 500 N
Sensitivity of peak: 0.5% (2.5 N).

2. The pet food product according to claim 1,
wherein in the pet food grains, an arithmetic mean surface roughness Sa1 of first surfaces obtained by projecting the pet food grains in a first direction is less than 14 μm, and
an arithmetic mean surface roughness Sa2 of surfaces obtained by projecting the pet food grains in a direction other than the first direction is 14 μm or more.

3. The pet food product according to claim 1,
wherein in a case where hardnesses of 10 grains of the pet food grains are measured, an average of the hardnesses is 30 N or less.

4. The pet food product according to claim 2,
wherein a height of the pet food grain in a case where a surface obtained by projecting the pet food grain in a second direction orthogonal to the first direction is defined as a bottom surface is larger than a length of the pet food grain in the first direction.

5. The pet food product according to claim 4,
wherein in a case where the heights of 10 grains of the pet food grains are measured, an average of the heights is 10 mm or more.

6. A pet food product comprising:
at least 10 or more grains of pet food grains having the same configuration and the same form,
wherein in a case where a breaking force upon compression of 10 grains of the pet food grains at a constant compression speed under the following test conditions is measured, the pet food product has 70% or more of pet food grains having a total weight of fragments remaining in a 7 mm×7 mm mesh, which is 90% or more of the weight before the measurement,
<Test Conditions>
Compression tester (texture analyzer, model number: EZ-SX, manufactured by Shimadzu Corporation)
Plunger: Canine-like plunger having a diameter of 10 mm
Platform: Flat plate (inner diameter of 26.5 mm×depth of 4 mm)
Compression speed: 60 mm/min
Lowest point of plunger: 4.0 mm (compression distance)
Measurement temperature: 25 °C
Break detection start point: 0.035% (0.14 N)
Test force: Full scale 500 N
Sensitivity of peak: 0.5% (2.5 N)
